(19) United States
(12) Patent Application Publication
(10) Pub. No.: US 2026/0049853 A1
(43) Pub. Date: Feb. 19, 2026

(54) VIBRATING TYPE FLUID FLOW METER COMPRISING A FLOW TUBE BUMPER

(71) Applicant: MICRO MOTION, INC., Boulder, CO (US)

(72) Inventors: Anthony William PANKRATZ, Arvada, CO (US); David SKINKLE, Boulder, CO (US); Jeffrey NIELSON, Longmont, CO (US); Kevin M. SCOTT, Lyons, CO (US)

(73) Assignee: MICRO MOTION, INC., Boulder, CO (US)

(21) Appl. No.: 19/371,167

(22) Filed: Oct. 28, 2025

Related U.S. Application Data
(63) Continuation of application No. 18/701,509.

(51) Int. Cl. G01F 1/84

(52) U.S. Cl. CPC G01F 1/8413

(57) ABSTRACT

A transducer assembly 200 for a vibrating meter 5 having meter electronics 20 is provided according to an embodiment. The transducer assembly 200 comprises a coil portion 204A comprising a coil bobbin 220 and a coil 222 wound around the coil bobbin 220. A magnet portion 204B comprises a magnet. The coil portion 204A and the magnet portion 204B are constrained in both the x and y axis of travel, such that the coil portion 204A is prevented from colliding with the magnet portion 204B.

### CROSS-REFERENCE TO RELATED APPLICATIONS

This application is a continuation of application Ser. No. 18/701,509, which is the National Stage of International Application No. PCT/US2021/059094, filed Nov. 12, 2021.

### TECHNICAL FIELD

The embodiments described below relate to vibrating meters, and more particularly, to a flow tube bumper for a vibrating fluid meter.

### BACKGROUND OF THE INVENTION

Vibrating meters, such as for example, vibrating densitometers and Coriolis flow meters are generally known and are used to measure mass flow and other information for materials within a conduit. The material may be flowing or stationary. Exemplary Coriolis flow meters are disclosed in U.S. Pat. Nos. 4,109,524, 4,491,025, and Re. 31,450 all to J. E. Smith et al. These flow meters have one or more conduits of straight or curved configuration. Each conduit configuration in a Coriolis mass flow meter has a set of natural vibration modes, which may be of simple bending, torsional, or coupled type. Each conduit can be driven to oscillate at a preferred mode.

Material flows into the flow meter from a connected pipeline on the inlet side of the flow meter, is directed through the conduit(s), and exits the flow meter through the outlet side of the flow meter. The natural vibration modes of the vibrating, material filled system are defined in part by the combined mass of the conduits and the material flowing within the conduits.

When there is no flow through the flow meter, a driving force applied to the conduit(s) causes all points along the conduit(s) to oscillate with identical phase or a small “zero offset”, which is a time delay measured at zero flow. As material begins to flow through the flow meter, Coriolis forces cause each point along the conduit(s) to have a different phase. For example, the phase at the inlet end of the flow meter lags the phase at the centralized driver position, while the phase at the outlet leads the phase at the centralized driver position. Pick-off sensors on the conduit(s) produce sinusoidal signals representative of the motion of the conduit(s). Signals output from the pick-off sensors are processed to determine the time delay between the pick-off sensors. The time delay between the two or more pick-off sensors is proportional to the mass flow rate of material flowing through the conduit(s).

Meter electronics connected to the driver generates a drive signal to operate the driver and determines a mass flow rate and other properties of a material from signals received from the pick-off sensors. The driver may comprise one of many well-known arrangements; however, a magnet and an opposing drive coil have received great success in the vibrating meter industry. Examples of suitable drive coil and magnet arrangements are provided in U.S. Pat. No. 7,287,438 as well as U.S. Pat. No. 7,628,083, which are both assigned on their face to Micro Motion, Inc. and are hereby incorporated by reference. An alternating current is passed to the drive coil for vibrating the conduit(s) at a desired flow tube amplitude and frequency. It is also known in the art to provide the pick-off sensors as a magnet and coil arrangement very similar to the driver arrangement. However, while the driver receives a current, which induces a motion, the pick-off sensors can use the motion provided by the driver to induce a voltage. The voltage is proportional to conduit displacement. The magnitude of the time delay measured by the pick-off sensors is very small; often measured in nanoseconds. Therefore, it is necessary to have the transducer output be very accurate.

FIG. 1 illustrates an example of a prior art vibrating meter 5 in the form of a Coriolis flow meter comprising a sensor assembly 10 and a meter electronics 20. The meter electronics 20 is in electrical communication with the sensor assembly 10 to measure characteristics of a flowing material, such as, for example, density, mass flow rate, volume flow rate, totalized mass flow, temperature, and other information.

The sensor assembly 10 includes a pair of flanges 101 and 101′, manifolds 102 and 102′, and conduits 103A and 103B. Manifolds 102, 102′ are affixed to opposing ends of the conduits 103A, 103B. Flanges 101 and 101′ of the prior art Coriolis flow meter are affixed to opposite ends of the spacer 106. The spacer 106 maintains the spacing between manifolds 102, 102′ to prevent undesired vibrations in the conduits 103A and 103B. The conduits 103A and 103B extend outwardly from the manifolds in an essentially parallel fashion. When the sensor assembly 10 is inserted into a pipeline system (not shown) which carries the flowing material, the material enters sensor assembly 10 through flange 101, passes through the inlet manifold 102 where the total amount of material is directed to enter conduits 103A and 103B, flows through the conduits 103A and 103B and back into the outlet manifold 102′ where it exits the sensor assembly 10 through the flange 101′.

The prior art sensor assembly 10 includes a driver 104. The driver 104 is affixed to conduits 103A and 103B in a position where the driver 104 can vibrate the conduits 103A, 103B in the drive mode, for example. More particularly, the driver 104 includes a first driver component 104A affixed to the conduit 103A and a second driver component 104B affixed to the conduit 103B. The driver 104 may comprise one of many well-known arrangements such as a coil mounted to the conduit 103A and an opposing magnet mounted to the conduit 103B.

In the present example of the prior art Coriolis flow meter, the drive mode is the first out of phase bending mode and the conduits 103A, 103B are selected and appropriately mounted to inlet manifold 102 and outlet manifold 102′ so as to provide a balanced system having substantially the same mass distribution, moments of inertia, and elastic moduli about bending axes W-W and W′-W′, respectively. In the present example, where the drive mode is the first out of phase bending mode, the conduits 103A and 103B are driven by the driver 104 in opposite directions about their respective bending axes W-W and W′-W′. A drive signal in the form of an alternating current can be provided by the meter electronics 20, such as for example via pathway 110, and passed through the coil to cause both conduits 103A, 103B to oscillate. Those of ordinary skill in the art will appreciate that other drive modes may be used by the prior art Coriolis flow meter.

The sensor assembly 10 shown includes a pair of pick-offs 105, 105′ that are affixed to the conduits 103A, 103B. More particularly, first pick-off components 105A and 105′A are located on the first conduit 103A and second pick-off components 105B and 105′B are located on the second conduit 103B. In the example depicted, the pick-offs 105, 105′ may be electromagnetic detectors, for example, pick-off magnets and pick-off coils that produce pick-off signals that represent the velocity and position of the conduits 103A, 103B. For example, the pick-offs 105, 105′ may supply pick-off signals to the meter electronics 20 via pathways 111, 111′. Those of ordinary skill in the art will appreciate that the motion of the conduits 103A, 103B is generally proportional to certain characteristics of the flowing material, for example, the mass flow rate and the density of the material flowing through the conduits 103A, 103B. However, the motion of the conduits 103A, 103B also includes a zero-flow delay or offset that can be measured at the pick-offs 105, 105′. The zero-flow offset can be caused by a number of factors such as non-proportional damping, residual flexibility response, electromagnetic crosstalk, or phase delay in instrumentation.

The prior art sensor assemblies 103, 104, and 105 are aligned on the axis of the coil to minimize air gap in the magnetic circuit and maximize the coupling between the magnet and coil fields. Generally, the keeper assembly is mounted to a first conduit, while the coil assembly is mounted to a second conduit (the arrangement is different for single conduit meters). The keeper and coil must be carefully mounted to maximize clearance between the components.

Unfortunately, coil and keeper assemblies can make contact under certain conditions, with the result being a damaged and likely non-functional flowmeter. For example, manufacturing variation may result in axial misalignment. In another circumstance, a slug of fluid that travels through one conduit to a greater extent than the mating conduit can cause inertial forces and relative lateral motion between the tubes such that magnet/coil/keeper contact occurs and damage to the assembly is the result. In yet another example, temperature differentials may result in coil and keeper assembly contact. Hot fluid flowing through one conduit at a time point significantly earlier than flowing through the mating conduit may result in uneven conduit expansion to the extent that the coil/keeper clearance limits are exceeded, and contact is made.

Therefore, as can be appreciated, the traditional transducer assembly may, under a number of circumstances potentially encountered during normal meter operation, be prone to suffering damage due to misalignment. There exists a need in the art for a transducer assembly sensor that is immune from unintentional contact and the resultant damage. The embodiments described below overcome these and other problems and an advance in the art is achieved.

### SUMMARY OF THE INVENTION

A transducer assembly for a vibrating meter having meter electronics is provided according to an embodiment. The transducer assembly comprises a coil portion comprising a coil bobbin and a coil wound around the coil bobbin. A magnet portion comprises a magnet. The coil portion and the magnet portion are constrained in both the x and y axis of travel, such that the coil portion is prevented from colliding with the magnet portion.

A flowmeter is provided according to an embodiment. The flowmeter comprises meter electronics, a first conduit, a second conduit, and a magnet portion comprising a magnet, wherein the magnet portion is attached to the first conduit. A coil portion comprises a coil bobbin and a coil wound around the coil bobbin, wherein the coil portion is attached to the second conduit. A physical stop is attached to each of the first conduit and second conduit, wherein the physical stops are configured to contact each other to limit conduit travel, wherein the coil portion and a magnet portion are prevented from colliding with each other.

A method of forming a vibrating meter including a sensor assembly with one or more conduits is provided according to an embodiment. The method comprises steps of affixing a coil portion to a conduit, affixing a magnet portion to a different conduit, and wherein the coil portion and the magnet portion are constrained such that the coil portion is prevented from colliding with the magnet portion.

### Aspects

According to an aspect, a transducer assembly for a vibrating meter having meter electronics comprises a coil portion comprising a coil bobbin and a coil wound around the coil bobbin. A magnet portion comprises a magnet. The coil portion and the magnet portion are constrained in both the x and y axis of travel, such that the coil portion is prevented from colliding with the magnet portion.

Preferably, a keeper bracket assembly comprises a first bracket attached to a conduit, wherein the magnet portion is attached to the first bracket. A second bracket is attached to another conduit, wherein the coil portion is attached to the second bracket. A limit extends from the first bracket to proximate a space in the second bracket, wherein contact between the limit and a wall of the space defines a travel limit between the first bracket and the second bracket.

Preferably, the limit concentrically occupies the space with regard to a wall of the space.

Preferably, the transducer assembly comprises a second limit extending from the second bracket to proximate a space in the first bracket, wherein contact between the second limit and a wall of the space defines a second travel limit between the first bracket and the second bracket.

Preferably, at least one weight is provided on at least one of the first and second brackets to maintain conduit to conduit mass balance and moment of inertia about a central vertical axis.

According to an aspect, a flowmeter comprises meter electronics, a first conduit, a second conduit, and a magnet portion comprising a magnet, wherein the magnet portion is attached to the first conduit. A coil portion comprises a coil bobbin and a coil wound around the coil bobbin, wherein the coil portion is attached to the second conduit. A physical stop is attached to each of the first conduit and second conduit, wherein the physical stops are configured to contact each other to limit conduit travel, wherein the coil portion and a magnet portion are prevented from colliding with each other.

Preferably, the physical stops comprise first and second plates, wherein each plate comprises tines formed on one side of the plate and slots formed on an opposing side of the plate. A nested fork region is formed when the tines are placed into the slots with a clearance fit, wherein a width of each tine is less than a width of each slot, and wherein a clearance gap between the tines and the slots dictates a magnitude of allowable conduit travel about an X axis of the flowmeter before an occurrence of contact between the tines and the slots, wherein the clearance gap is configured to be smaller than the distance between the coil portion and magnet portion of a transducer assembly.

Preferably, the physical stops comprise bars, and each conduit comprises a bar, and wherein the bars are configured to nest with each other. A limit is inserted into an aperture defined by the end of at least one nested bar.

Preferably, an aperture is defined by an end of a nested bar, and a limit is placed into the aperture. A distance the limit protrudes into a space determines the amount of motion in the X axis the conduits may travel before the nested bars collide and prevent further travel.

Preferably, the limit is threaded, and the aperture comprises mating threads.

Preferably, the limit is affixed in place.

According to an aspect, a method of forming a vibrating meter including a sensor assembly with one or more conduits comprises the steps of affixing a coil portion to a conduit, affixing a magnet portion to a different conduit, and wherein the coil portion and the magnet portion are constrained such that the coil portion is prevented from colliding with the magnet portion.

Preferably, the coil portion and the magnet portion are constrained in both the x and y axis of travel.

Preferably, the method further comprises the steps of attaching a first bracket to the conduit, wherein the magnet portion is attached to the first bracket, attaching a second bracket to the conduit, wherein the coil portion is attached to the second bracket, and extending a limit from the first bracket to proximate a space in the second bracket, wherein contact between the limit and a wall of the space defines a travel limit between the first bracket and the second bracket.

Preferably, the coil portion and the magnet portion are constrained in the x axis of travel by a physical stop.

Preferably, the physical stop comprises bars, and each conduit comprises a bar, wherein the bars are configured to nest with each other. A limit is inserted into an aperture defined by the end of at least one nested bar, wherein a distance the limit protrudes into a space between the nested bars determines the amount of motion in the X axis the conduits may travel before the nested bars collide and prevent further travel.

Preferably, the physical stop comprises first and second plates. And tines are formed on one side of the plate. Slots are formed on an opposing side of the plate. A nested fork region is formed when the tines are placed into the slots with a clearance fit, wherein a width of each tine is less than a width of each slot, and wherein a clearance gap between the tines and the slots dictates a magnitude of allowable conduit travel about the X axis of the flowmeter before an occurrence of contact between the tines and the slots, wherein the clearance gap is configured to be smaller than the distance between the coil portion and magnet portion of a transducer assembly.

### BRIEF DESCRIPTION OF THE DRAWINGS

FIG. 1 illustrates a fluid meter;

FIG. 2 illustrates a cross-sectional view of a prior art transducer assembly;

FIG. 3 illustrates a flowmeter physical stop embodiment;

FIG. 4 illustrates an alternate view of the physical stop of FIG. 3;

FIG. 5 illustrates another flowmeter physical stop embodiment;

FIG. 6 illustrates an alternate view of the physical stop of FIG. 5;

FIG. 7 illustrates a modified coil and keeper bracket assembly according to an embodiment; and

FIG. 8 illustrates an alternate view of the coil and keeper bracket assembly of FIG. 7.

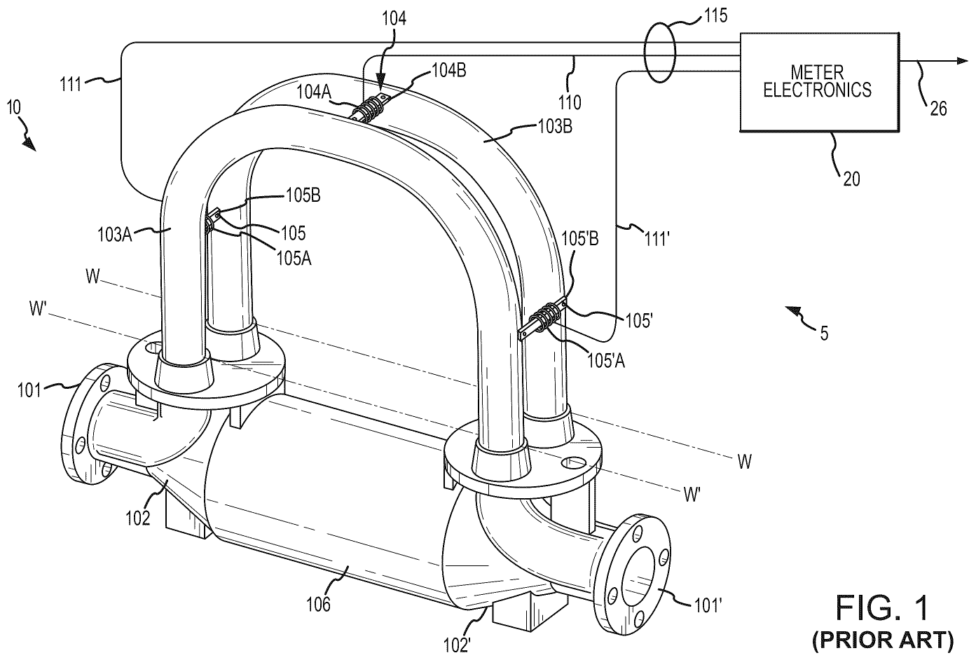

### DETAILED DESCRIPTION OF THE INVENTION

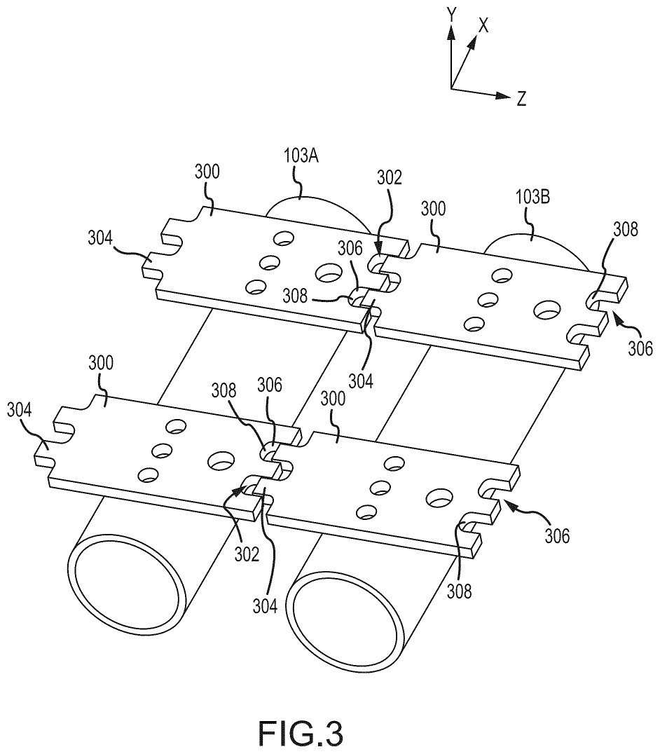

FIGS. 3-7 and the following description depict specific examples to teach those skilled in the art how to make and use the best mode of embodiments of a transducer. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the fluid meter. As a result, the embodiments described below are not limited to the specific examples described below, but only by the claims and their equivalents.

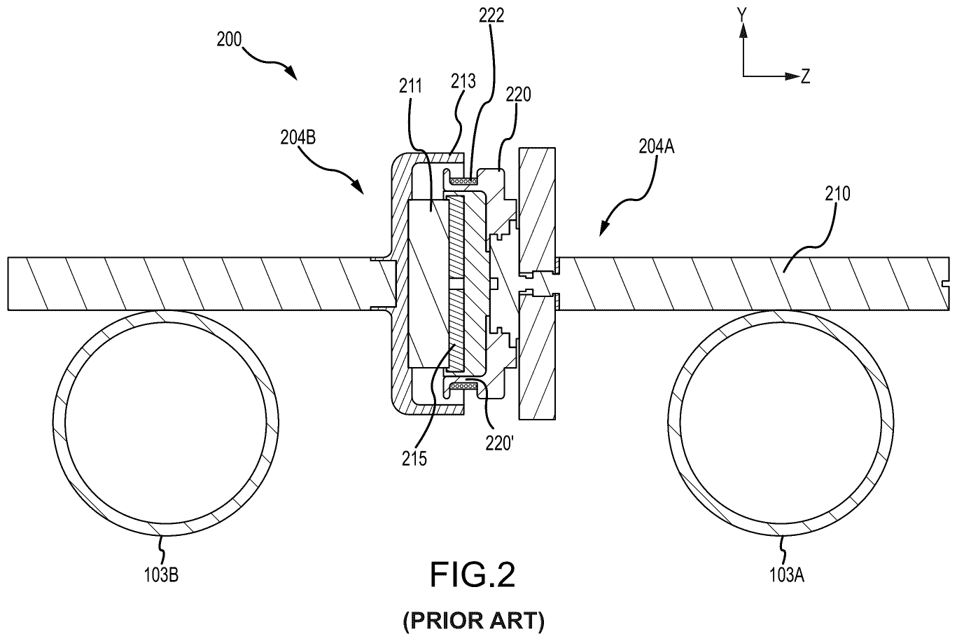

FIG. 2 shows a cross-sectional view of a prior art transducer assembly 200. The transducer assembly 200 can be coupled to the first and second flow conduits 103A, 103B. The prior art transducer assembly 200 comprises a coil portion 204A and a magnet portion 204B. The magnet portion 204B comprises a magnet 211. The magnet 211 can be positioned within a magnet keeper 213 that can help direct the magnetic field. The magnet portion 204B may also comprise a pole piece 215. The magnet portion 204B comprises a typical magnet portion of prior art sensor components. The magnet portion 204B may be coupled to the second flow conduit 103B with a mounting bracket (not shown for clarity). The mounting bracket may be coupled to the flow conduit 103B according to well-known techniques such as welding, brazing, bonding, etc.

The coil portion 204A may be coupled to the first flow conduit 103A with a mounting bracket (not shown for clarity). The mounting bracket may be coupled to the flow conduit 103A according to well-known techniques such as welding, brazing, bonding, etc.

The coil portion 204A also comprises a coil bobbin 220. The coil bobbin 220 can include a magnet receiving portion 220′ for receiving at least a portion of the magnet 211. The coil bobbin 220 comprises a coil 222. The coil bobbin 220 can be held onto the mounting bracket 210 with a fastening device.

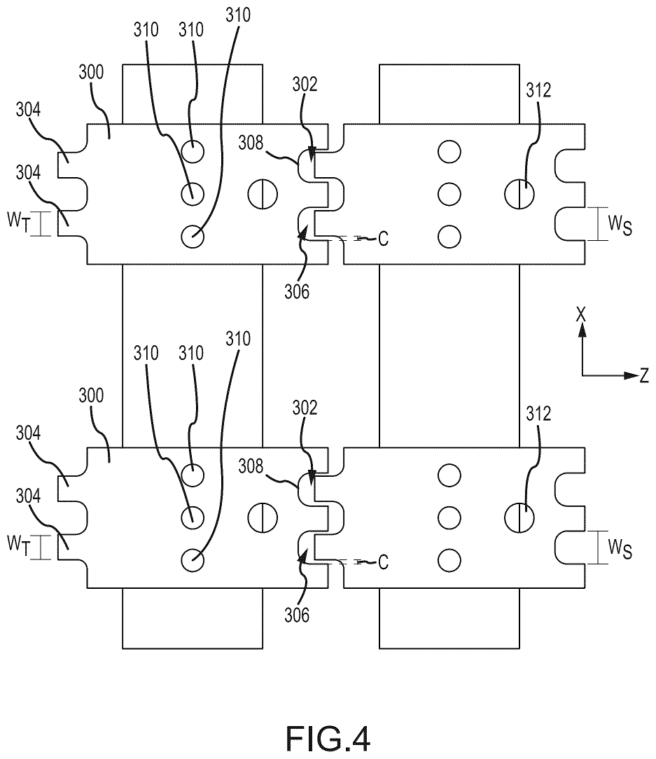

FIGS. 3 and 4 illustrate an embodiment of the invention that provides physical stops to prevent the coil portion 204A and magnet portion 204B of a transducer assembly 200 from colliding with each other in a range of motion related to conduit 103A, 103B travel about the X axis. Plates 300 are provided that are attachable to conduits 103A, 103B. Plates 300 are preferably soldered, welded, brazed, adhered, and/or mechanically attached to the conduits 103A, 103B. The plates 300 may be stamped, machined or otherwise subtractive manufactured, or additively manufactured. For flowmeters with metal conduits 103A, 103B, the plates 300 are preferably made from metal so to accommodate soldering, welding, or brazing. For plates 300 used on non-metallic conduits 103A, 103B the plates 300 may be made from non-metallic materials, such as plastics, polymers, ceramics, composites, and any other material known in the art.

The same shaped plate may be utilized for both the conduits 103A, 103B. This reduces the cost of manufacturing, as only a single design need be made, merely in multiples. Furthermore, the symmetric design prevents installation errors, as only a single orientation will fit together during the assembly process.

A nested fork region 302 provides that tines 304 formed on one side of the plate 300 fit in the slot 306 formed in a proximate plate 300 with a clearance fit. The tines 304 do not extend all the way to the root 308 of the slots 306. The width of each tine 304, W_{T}, is less than the width of each slot 306, W_{S}. It is the clearance gap, C, between the tines 304 and the slots 306 that dictates the magnitude of allowable conduit 103A, 103B travel about the X axis before contact between the tines 304 and the slots 306. The clearance gap is configured to be smaller than the distance between the coil portion 204A and magnet portion 204B of a transducer assembly 200, thus preventing collisions between the coil portion 204A and magnet portion 204B.

In an embodiment braze paste holes 310 are formed in each plate 300. Although three holes are illustrated, more or less than three holes may be present. Braze paste holes 310 may contain brazing filler material for manufacturing purposes.

One or more balance holes 312 may be defined by the plate 300 in an embodiment. The balance holes 312 are sized to remove material such that the mass of the plate 300 is balanced about the flow conduit centerline to which it is attached, the braze paste holes 310, or both the flow conduit centerline and the braze paste holes.

Although two tines 304 and two slots 306 are illustrated, both the size and number of tines 304 and slots 306 may be varied to alter part mass and/or deformation strength.

Although brazing is contemplated for attachment to flow conduits, welding, mechanical attachment, and adhesive attachment are also contemplated.

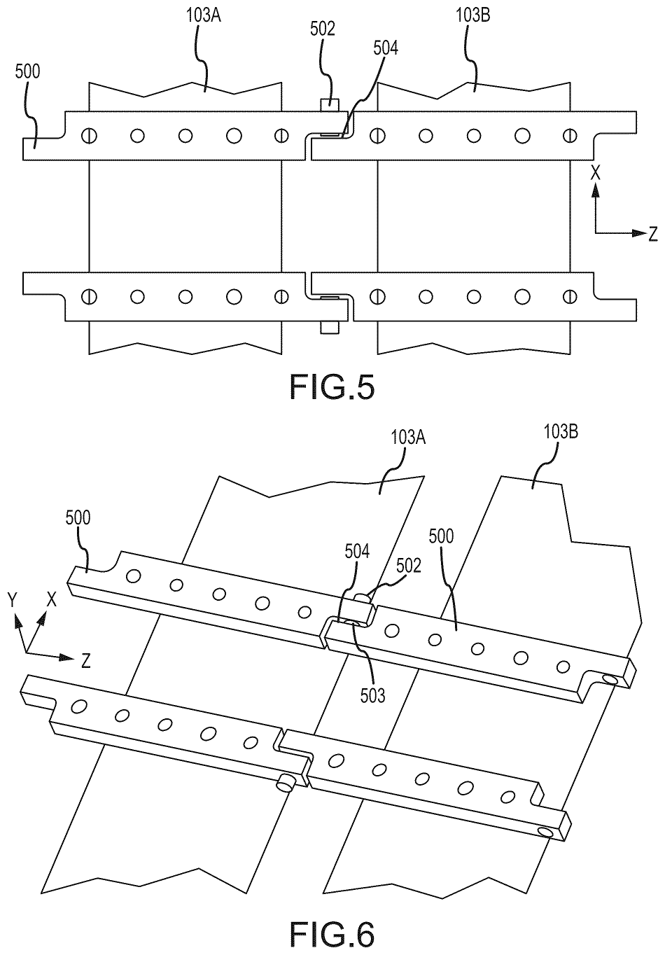

FIGS. 5 and 6 illustrate an alternate embodiment that provides physical stops to prevent the coil portion 204A and magnet portion 204B of a transducer assembly 200 from colliding with each other in a range of motion related to conduit 103A, 103B travel about the X axis.

This embodiment is constructed by first affixing two pair of nested bars 500 to the tubes by welding, brazing, bonding, clamping or any combination of methods. A limit 502 is inserted into an aperture 503 defined by the end of one nested bar 500. The distance the limit 502 protrudes into a space 504 determines the amount of motion in the X axis the conduits 103A, 103B may travel before the nested bars 500 collide and prevent further travel.

During manufacturing, in an embodiment, the limit 502 is advanced until it reaches a spacer (not shown) inserted into the space, wherein the spacer is a thickness representing the amount of motion in the X axis the conduits 103A, 103B may travel before the nested bars 500 collide. The limit 502 is then bonded, tack welded, lock wired or secured by other means into position. The spacer is removed to provide clearance so the tubes may vibrate in the Z axis.

In an embodiment, the limit 502 is threaded, and the aperture 503 comprises mating threads. In an embodiment, the limit 502 is a screw. Providing a screw, or any other embodiment of limit 502, allows the manufacture to precisely limit the x-axis travel of one tube relative to the other and compensate for imperfect bar alignment and sensor distortion as the sensor assembly passes through braze and weld processes. In an embodiment the limit 502 is affixed in place after adjustment, by adhesive, thread-lock, welding, brazing, or mechanical means.

In the embodiment illustrated the nested bars 500 are symmetric. This prevents assembly error, as the assembly orientation will be obvious to a manufacturer. Furthermore, only a single design need be manufactured, thus reducing manufacturing costs. Additionally, identical parts help maintain conduit to conduit mass balance.

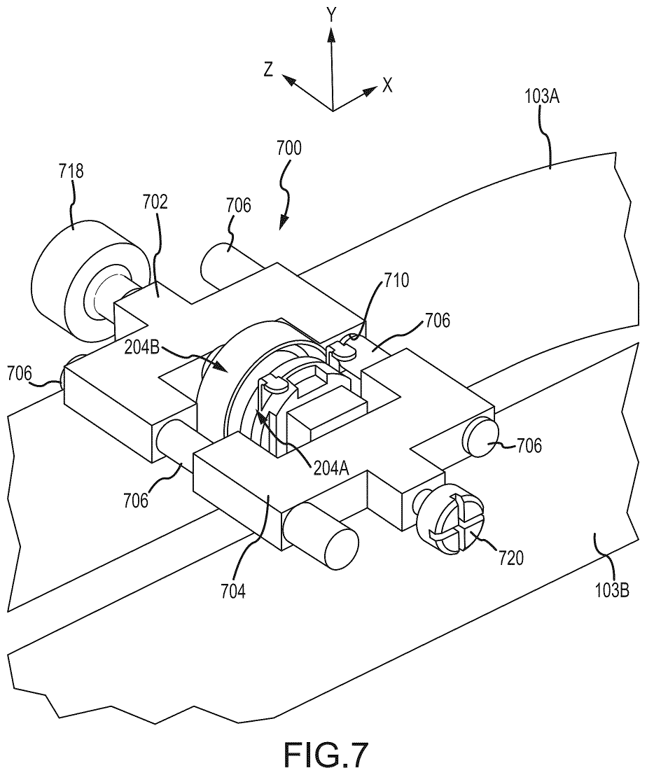

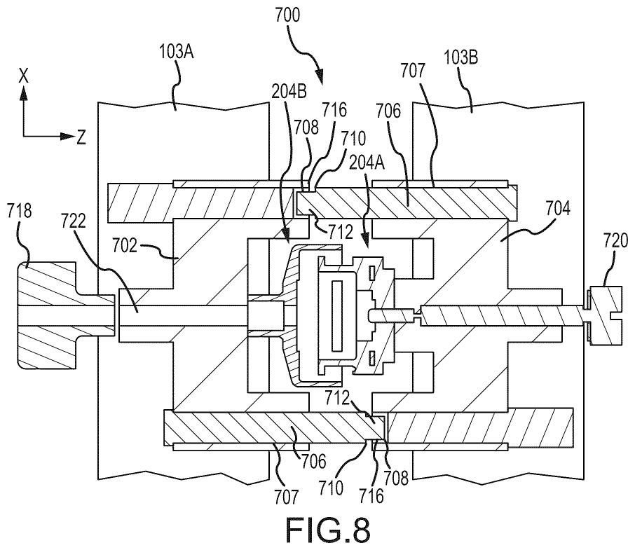

FIGS. 7 and 8 illustrate a modified coil and keeper bracket assembly 700. In this embodiment, each conduit 103A, 103B has a portion of the keeper bracket assembly 700 attached thereto. One conduit 103A has a first bracket 702 attached thereto, while the other conduit 103B has a second bracket 704 attached thereto. The first bracket 702 serves as the physical mount for the magnet portion 204B of a transducer assembly 200, while the second bracket 704 serves as the physical mount for the coil portion 204A of a transducer assembly 200. The keeper bracket assembly 700 allows a prior art transducer assembly 200 to be mounted to conduits 103A, 103B, yet provide protection from unwanted travel in both the x and y axes. Each bracket 702, 704 defines at least one passageway 707 therethrough in which a limit 706 may pass. Each limit 706 extends from its respective bracket 702 or 704 to occupy a space 708 defined by the opposing bracket 704 or 702. In an embodiment, a shoulder 710 defined in each limit 706 defines a projection portion 712 that occupy a space 708 defined by the opposing bracket 704. Whether the limit 706 itself or the projection portion 712 thereof, the result of occupying the space 708 by the limit 706 is that x and y travel is limited by virtue of the space 708 between the limit 706 and contact with the wall 716 of the space 708. In an embodiment, the limit 706 concentrically occupies the space 708 with regard to the wall 716. This results in equal travel limits in the x and y direction.

In an embodiment at least one weight 718 is provided to maintain conduit to conduit mass balance and moment of inertia about a central vertical axis. The weight 718 position is adjustable so that mass balance and moment of inertia may be fine-tuned.

An adjustment screw 720 may be provided to adjust the distance of the coil portion 204A to the magnet portion 204B. Alternatively or additionally, an adjustment screw 722 may be provided to adjust the distance of the magnet portion 204B to the coil portion 204A.

As illustrated, the limit 706 configuration comprises a symmetric design that prevents assembly error, as only a properly coupled bracket assembly 700 can be implemented. Although brazing is contemplated for attachment of the bracket assembly 700 to flow conduits, welding, mechanical attachment, clamping, and adhesive attachment are also contemplated.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other fluid meters, and not just to the embodiments described above and shown in the accompanying figures. Accordingly, the scope of the embodiments should be determined from the following claims.

We claim:

1. A transducer assembly (200) for a vibrating meter (5) having meter electronics (20), comprising:
a coil portion (204A) comprising a coil bobbin (220) and a coil (222) wound around the coil bobbin (220);
a magnet portion (204B) comprising a magnet (211);
wherein the coil portion (204A) and the magnet portion (204B) are constrained in both the x and y axis of travel, such that the coil portion (204A) is prevented from colliding with the magnet portion (204B).

2. The transducer assembly (200) of claim 1, wherein a keeper bracket assembly (700) comprises:
a first bracket (702) attached to a conduit (103A), wherein the magnet portion (204B) is attached to the first bracket (702);
a second bracket (704), attached to another conduit (103B), wherein the coil portion (204A) is attached to the second bracket (704);
a limit (706) extending from the first bracket (702) to proximate a space (708) in the second bracket (704), wherein contact between the limit (706) and a wall (716) of the space (708) defines a travel limit between the first bracket (702) and the second bracket (704).

3. The transducer assembly (200) of claim 2, wherein the limit (706) concentrically occupies the space (708) with regard to a wall (716) of the space (708).

4. The transducer assembly (200) of claim 2, comprising a second limit (706) extending from the second bracket (704) to proximate a space (708) in the first bracket (702), wherein contact between the second limit (700) and a wall (716) of the space (708) defines a second travel limit between the first bracket (702) and the second bracket (704).

5. The transducer assembly (200) of claim 2, wherein at least one weight (718) is provided on at least one of the first and second brackets (702, 704) to maintain conduit (103A) to conduit (103B) mass balance and moment of inertia about a central vertical axis.

6. A flowmeter (5) comprising:
meter electronics (20)
a first conduit (103A);
a second conduit (103B);
a magnet portion (204B) comprising a magnet (211), wherein the magnet portion (204B) is attached to the first conduit (103A);
a coil portion (204A) comprising a coil bobbin (220) and a coil (222) wound around the coil bobbin (220), wherein the coil portion (204A) is attached to the second conduit (103B);
a physical stop attached to each of the first conduit (103A) and second conduit (103B), wherein the physical stops are configured to contact each other to limit conduit (103A, 103B) travel, wherein the coil portion (204A) and a magnet portion (204B) are prevented from colliding with each other.

7. The flowmeter (5) of claim 6, wherein the physical stops comprise:
first and second plates (300), wherein each plate (300) comprises tines (304) formed on one side of the plate (300) and slots (306) formed on an opposing side of the plate (300);
wherein a nested fork region (302) is formed when the tines (304) are placed into the slots (306) with a clearance fit, wherein a width of each tine (304) is less than a width of each slot (306), and wherein a clearance gap (C) between the tines (304) and the slots (306) dictates a magnitude of allowable conduit (103A, 103B) travel about an X axis of the flowmeter (5) before an occurrence of contact between the tines (304) and the slots (306), wherein the clearance gap (C) is configured to be smaller than the distance between the coil portion (204A) and magnet portion (204B) of a transducer assembly (200).

8. The flowmeter (5) of claim 6, wherein:
the physical stops comprise bars (500);
each conduit (103A, 103B) comprises a bar (500), and wherein the bars (500) are configured to nest with each other;
a limit (502) is inserted into an aperture (503) defined by the end of at least one nested bar (500).

9. The flowmeter (5) of claim 8, wherein:
an aperture (503) is defined by an end of a nested bar (500);
a limit (502) is placed into the aperture (503);
wherein a distance the limit (502) protrudes into a space (504) determines the amount of motion in the X axis the conduits (103A, 103B) may travel before the nested bars (500) collide and prevent further travel.

10. The flowmeter (5) of claim 8, wherein the limit (502) is threaded, and the aperture (503) comprises mating threads.

11. The flowmeter (5) of claim 8, wherein the limit (502) is affixed in place.

12. A method of forming a vibrating meter including a sensor assembly with one or more conduits, comprising steps of:
affixing a coil portion to a conduit;
affixing a magnet portion to a different conduit;
wherein the coil portion and the magnet portion are constrained such that the coil portion is prevented from colliding with the magnet portion.

13. The method of forming a vibrating meter of claim 12, wherein the coil portion and the magnet portion are constrained in both the x and y axis of travel.

14. The method of forming a vibrating meter of claim 13, comprising:
attaching a first bracket to the conduit, wherein the magnet portion is attached to the first bracket;
attaching a second bracket to the conduit, wherein the coil portion is attached to the second bracket;
extending a limit from the first bracket to proximate a space in the second bracket, wherein contact between the limit and a wall of the space defines a travel limit between the first bracket and the second bracket.

15. The method of forming a vibrating meter of claim 12, wherein the coil portion and the magnet portion are constrained in the x axis of travel by a physical stop.

16. The method of forming a vibrating meter of claim 15, wherein the physical stop comprises bars, and each conduit comprises a bar, and wherein the bars are configured to nest with each other; and
Inserting a limit into an aperture defined by the end of at least one nested bar, wherein a distance the limit protrudes into a space between the nested bars determines the amount of motion in the X axis the conduits may travel before the nested bars collide and prevent further travel.

17. The method of forming a vibrating meter of claim 15, wherein the physical stop comprises first and second plates;
forming tines on one side of the plate;
forming slots on an opposing side of the plate;
forming a nested fork region when the tines are placed into the slots with a clearance fit, wherein a width of each tine is less than a width of each slot, and wherein a clearance gap between the tines and the slots dictates a magnitude of allowable conduit travel about the X axis of the flowmeter before an occurrence of contact between the tines and the slots, wherein the clearance gap is configured to be smaller than the distance between the coil portion and magnet portion of a transducer assembly.
